(19) United States
(12) Patent Application Publication
(10) Pub. No.: US 2007/0158036 A1
(43) Pub. Date: Jul. 12, 2007

(54) Vertical blind having carrier mechanism

(76) Inventor: Ya-Yin Lin, Jiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/328,833

(22) Filed: Jan. 10, 2006

(51) Int. Cl. A47H 1/00; E05D 15/06

(52) U.S. Cl. 160/197; 160/126

(57) ABSTRACT

A vertical blind includes a headrail having a plurality of guide tracks, a carrier mechanism including a plurality of carriers slidably mounted on the guide tracks of the headrail, and a plurality of covering members attached to the carriers. Each of the carriers includes an elongated support plate, two fixing seats, and a bonding layer. Thus, the snapping recess of each of the fixing seats is snapped onto the support plate to secure the fixing seats to the support plate, and the bonding layer is clamped by the support plate and the fixing seats so as to assemble each of the carriers, so that the carriers are assembled easily and rapidly, thereby facilitating a user assembling the carriers.

### BACKGROUND OF THE INVENTION

1. Field of the Invention

The present invention relates to a window covering and, more particularly, to a vertical blind having a carrier mechanism.

2. Description of the Related Art

A conventional vertical blind comprises a headrail having a plurality of guide tracks, a carrier mechanism mounted on the headrail and including a plurality of carriers slidably mounted on the guide tracks of the headrail, and a plurality of covering members attached to the carriers of the carrier mechanism to move therewith.

A conventional carrier of the carrier mechanism in accordance with the prior art shown in FIG. 8 comprises an elongated support plate 60 having an upper portion formed with two fixing holes 600, two hook members 61 each having a lower portion secured to the respective fixing hole 600 of the support plate 60 and a hooked upper portion 610 attached to a slide (not shown) which is slidably mounted on the respective guide track (not shown) of the headrail (not shown), a bonding layer 62 mounted on a lower portion of the support plate 60 to attach a respective covering member (not shown) to the support plate 60 and having two ends 620 rested on the two ends of the support plate 60, two clamping seats 64 rested on the two ends 620 of the bonding layer 62, and two locking screws 66 extended through the clamping seats 64 and screwed into the two ends of the support plate 60 to secure the clamping seats 64 to the support plate 60 and to clamp the bonding layer 62 between the support plate 60 and the clamping seats 64.

However, the conventional carrier has a complicated construction, thereby increasing costs of fabrication. In addition, the conventional carrier is not assembled easily and rapidly, thereby causing inconvenience to a user when mounting the carrier. Further, the support plate 60 needs to prepare the fixing holes 600 for mounting the hook members 61, thereby increasing the costs of material. Further, the support plate 60 needs to prepare the fixing holes 600 for mounting the hook members 61, so that the support plate 60 is spaced from the headrail to increase the distance between the covering members and the headrail, thereby decreasing the aesthetic quality of the vertical blind. Further, the structure the support plate 60 is easily broken by the locking screws 66, thereby decreasing the lifetime of the carrier.

### SUMMARY OF THE INVENTION

In accordance with the present invention, there is provided a vertical blind, comprising a headrail having a plurality of guide tracks, a carrier mechanism mounted on the headrail and including a plurality of carriers slidably mounted on the guide tracks of the headrail, and a plurality of covering members attached to the carriers of the carrier mechanism to move therewith. Each of the carriers includes an elongated support plate, two fixing seats secured on a first side of the support plate respectively and each provided with a transversely extending push arm and an upwardly extending hook portion, and a bonding layer secured on a second side of the support plate and bonded to a respective one of the covering members to attach each of the covering members to the respective carrier.

The primary objective of the present invention is to provide a vertical blind having a carrier mechanism that is assembled easily and rapidly, thereby facilitating a user mounting the vertical blind.

Another objective of the present invention is to provide a vertical blind, wherein the snapping recess of each of the fixing seats is snapped onto the support plate to secure the fixing seats to the support plate, and the bonding layer is clamped by the support plate and the fixing seats so as to assemble each of the carriers, so that the carriers are assembled easily and rapidly, thereby facilitating a user assembling the carriers.

A further objective of the present invention is to provide a vertical blind, wherein each of the carriers consists of the support plate, the bonding layer and the fixing seats, so that each of the carriers has a simplified construction, thereby decreasing costs of fabrication.

A further objective of the present invention is to provide a vertical blind, wherein the snapping recess of each of the fixing seats is snapped onto the support plate to reduce the volume of each of the carriers largely, so that the carriers are closer to the headrail to reduce the distance between the covering members and the headrail, thereby enhancing the aesthetic quality of the vertical blind.

A further objective of the present invention is to provide a vertical blind, wherein the snapping recess of each of the fixing seats is directly snapped onto the support plate, so that the support plate needs to prepare an area to combine each of the fixing seats, thereby decreasing the costs of material.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a vertical blind in accordance with the preferred embodiment of the present invention.

FIG. 2 is a partially enlarged exploded perspective view of the vertical blind as shown in FIG. 1.

FIG. 3 is a partially enlarged exploded perspective view of the vertical blind as shown in FIG. 1.

FIG. 4 is an exploded perspective view of the vertical blind as shown in FIG. 3.

FIG. 4A is a perspective view of a fixing seat of the vertical blind in accordance with another preferred embodiment of the present invention.

FIG. 5 is a bottom plan view of the vertical blind as shown in FIG. 1.

FIG. 6 is a bottom plan view of a vertical blind in accordance with another preferred embodiment of the present invention.

FIG. 7 is a perspective view of a fixing seat of the vertical blind in accordance with another preferred embodiment of the present invention.

FIG. 8 is an exploded perspective view of a conventional vertical blind in accordance with the prior art.

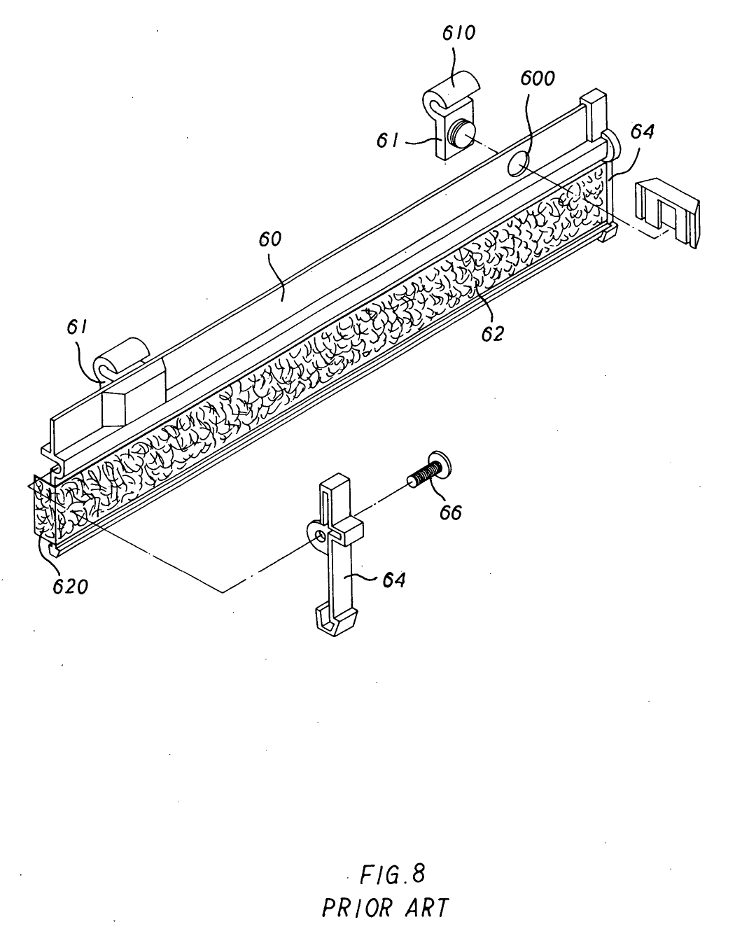

### DETAILED DESCRIPTION OF THE INVENTION

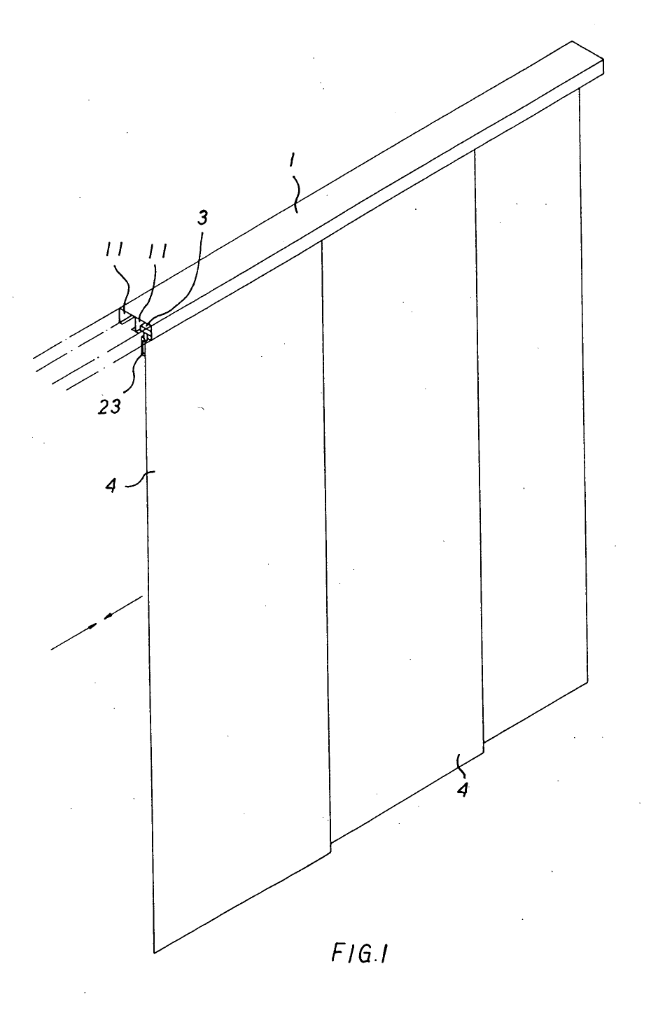

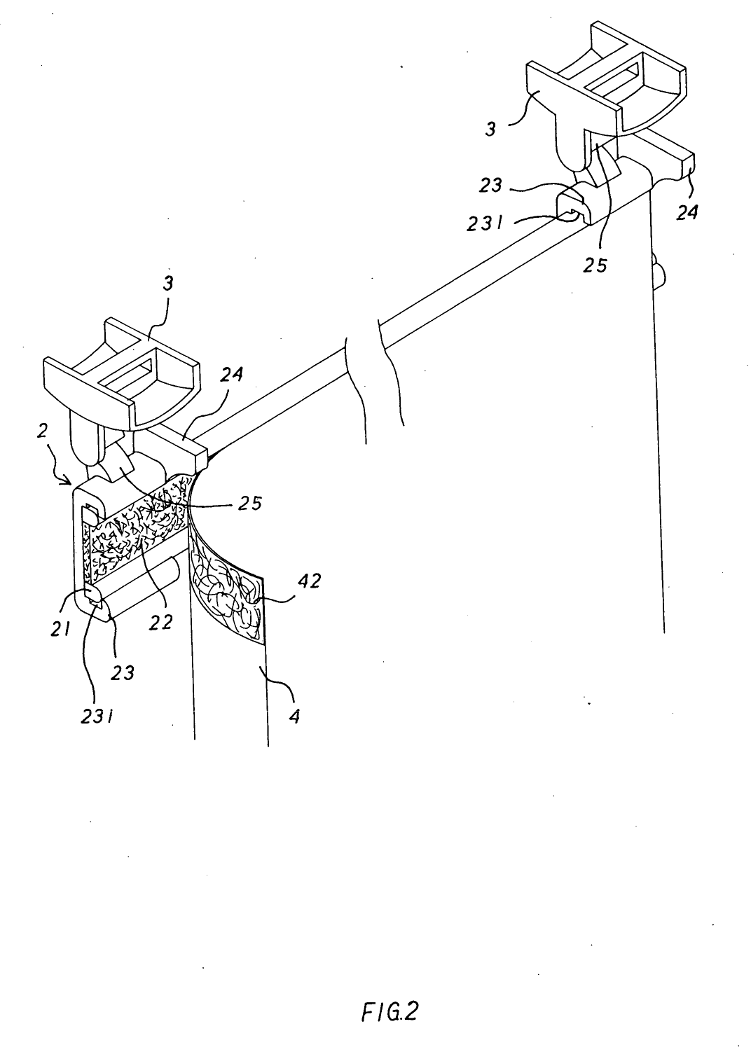

Referring to the drawings and initially to FIGS. 1-5, a vertical blind in accordance with the preferred embodiment of the present invention comprises a headrail 1 having a plurality of (preferably two) guide tracks 11, a carrier mechanism mounted on the headrail 1 and including a plurality of carriers 2 slidably mounted on the guide tracks 11 of the headrail 1, and a plurality of covering members 4 attached to the carriers 2 of the carrier mechanism to move therewith.

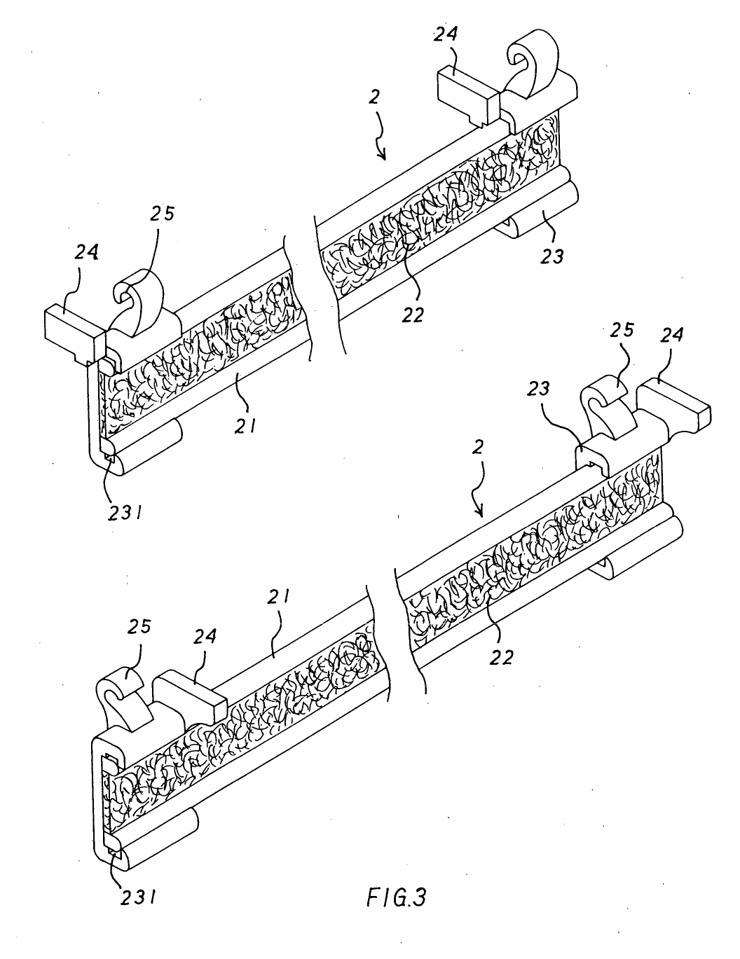

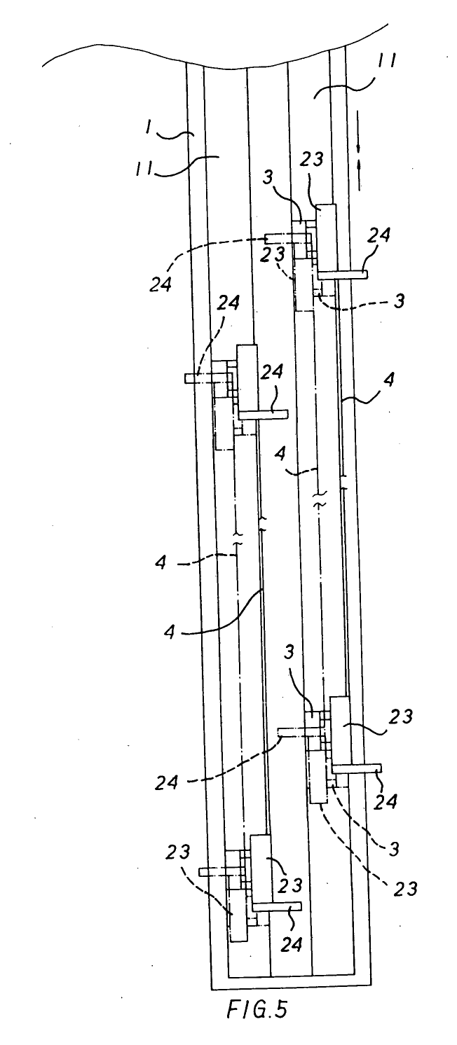

The carriers 2 of the carrier mechanism are arranged in pairs in the guide tracks 11 of the headrail 1 in a staggered manner, so that any two adjacent carriers 2 are juxtaposed to form multiple pairs of carriers 2 as shown in FIGS. 3 and 5.

Each of the carriers 2 includes an elongated support plate 21, two fixing seats 23 secured on a first side of the support plate 21 respectively and each provided with a transversely extending push arm 24 and an upwardly extending hook portion 25, two slides 3 each hooked on the hook portion 25 of a respective one of the fixing seats 23 and each slidably mounted on a respective one of the guide tracks 11 of the headrail 1, and a bonding layer 22 secured on a second side of the support plate 21 and bonded to a respective one of the covering members 4 to attach each of the covering members 4 to the respective carrier 2.

The support plate 21 of each of the carriers 2 has two distal ends each formed with a fixing hole 211.

Each of the fixing seats 23 of each of the carriers 2 has an inside formed with a snapping recess 231 snapped onto the support plate 21 to secure each of the fixing seats 23 to the support plate 21. The snapping recess 231 of each of the fixing seats 23 has a cross-sectional profile corresponding to that of the support plate 21 to secure each of the fixing seats 23 to the support plate 21 closely. Each of the fixing seats 23 of each of the carriers 2 has a side formed with a fixing post 232 inserted into the respective fixing hole 211 of the support plate 21 to secure each of the fixing seats 23 to the support plate 21 rigidly and stably to prevent each of the fixing seats 23 from deflecting from the support plate 21.

The push arm 24 is located at and extended outward from a side of an upper portion of each of the fixing seats 23 of each of the carriers 2, and the hook portion 25 is located at and extended outward from the upper portion of each of the fixing seats 23 of each of the carriers 2 in an oblique manner.

The bonding layer 22 of each of the carriers 2 has two distal ends each formed with a bent portion 220 inserted between the first side of the support plate 21 and a respective one of the fixing seats 23, so that the bonding layer 22 is clamped by the support plate 21 and the fixing seats 23.

Each of the covering members 4 has an upper end provided with a bonding member 42 bonded onto the bonding layer 22 of the respective carrier 2.

As shown in FIGS. 3-5, each of the guide tracks 11 of the headrail 1 is provided with a pair of carriers 2, wherein the front and rear carriers 2 on each of the guide tracks 11 are arranged in a staggered manner. Thus, the slides 3 of the front and rear carriers 2 on each of the guide tracks 11 are arranged in a staggered manner as shown in FIG. 5. In addition, the push arms 24 of the fixing seats 23 of the front and rear carriers 2 on each of the guide tracks 11 are directed toward two opposite directions as shown in FIG. 5. In such a manner, the front carrier 2 on the same guide track 11 is located at a front portion of the rear carrier 2 in a staggered manner, and the rear carrier 2 on the front guide track 11 is located at a front portion of the front carrier 2 on the rear guide track 111 in a staggered manner as shown in FIG. 5. In addition, the push arm 24 of the rear carrier 2 on the front guide track 11 is directed toward the push arm 24 of the front carrier 2 on the rear guide track 11 in a staggered manner as shown in FIG. 5. Thus, the carriers 2 on the guide tracks 11 of the headrail 1 are in turn driven and moved serially so as to expand and fold the covering members 4 serially.

In operation, referring to FIGS. 1-5, after the front carrier 2 on the front (foremost) guide track 11 is pulled forward (or upward) as shown in FIG. 5, the rear slide 3 of the front carrier 2 on the front guide track 11 is moved forward to drive and move the front slide 3 of the rear carrier 2 on the front guide track 11 so as to move the rear carrier 2 on the front guide track 11 forward. Then, the rear push arm 24 of the rear carrier 2 on the front guide track 11 is moved forward to drive and move the front push arm 24 of the front carrier 2 on the rear guide track 11. Thus, the carriers 2 on the front guide track 11 push the carriers 2 on the rear guide track 11 to in turn move forward by interactions of the push arms 24 so that the covering members 4 are moved forward serially so as to expand the covering members 4 as shown in FIG. 1.

On the contrary, after the front carrier 2 on the front guide track 11 is pushed backward (or downward) as shown in FIG. 5, the front slide 3 of the front carrier 2 on the front guide track 11 is moved backward to drive and move the front slide 3 of the rear carrier 2 on the front guide track 11 so as to move the rear carrier 2 on the front guide track 11 backward. Then, the front push arm 24 of the rear carrier 2 on the front guide track 11 is moved backward to drive and move the front push arm 24 of the front carrier 2 on the rear guide track 11. Thus, the carriers 2 on the front guide track 11 push the carriers 2 on the rear guide track 11 to in turn move backward by interactions of the push arms 24 so that the covering members 4 are moved backward serially so as to fold the covering members 4.

In conclusion, the front and rear carriers 2 on each of the guide tracks 11 are linked by the slides 3 arranged in a staggered manner, so that the front and rear carriers 2 on each of the guide tracks 11 are moved simultaneously. In addition, the carriers 2 on each of the guide tracks 11 drives and moves the carriers 2 on an adjacent guide track 11 by the push arms 24. Thus, the carriers 2 are movable on the guide tracks 11 in a serial manner so as to expand and fold the covering members 4.

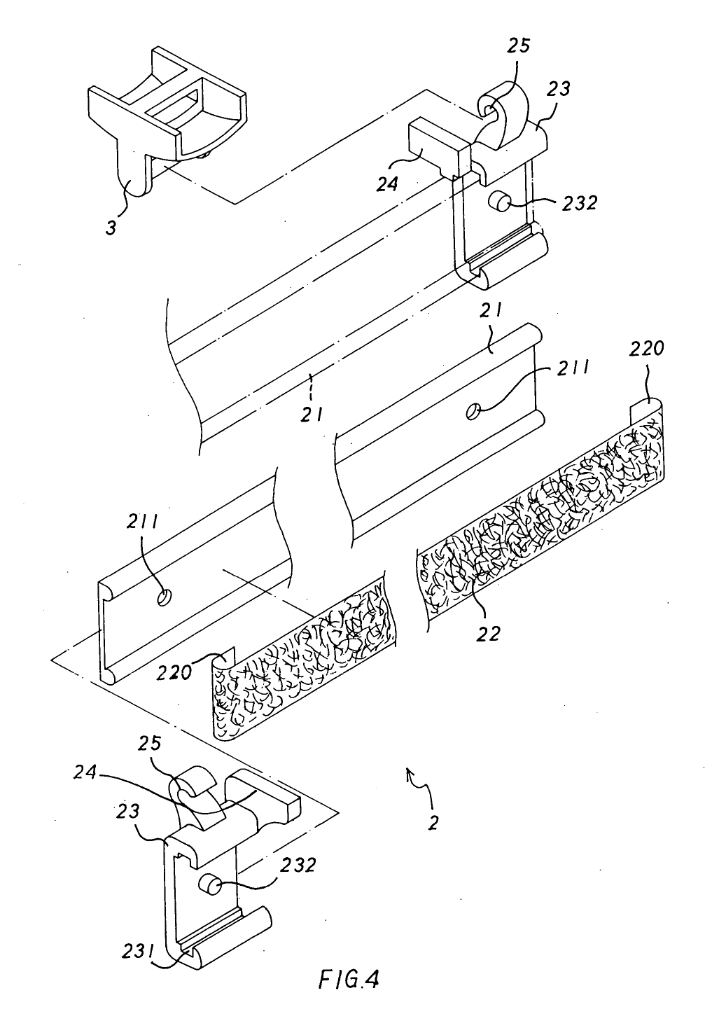

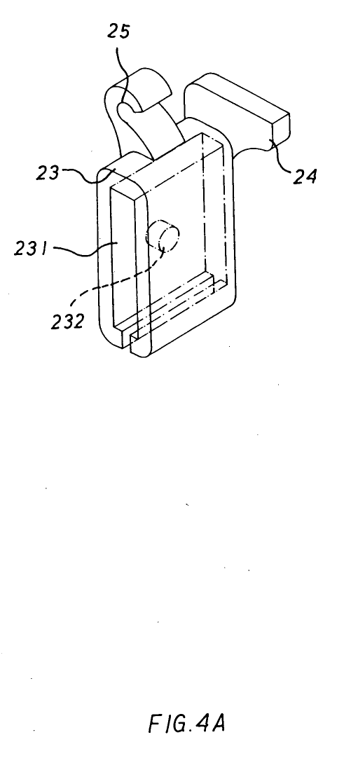

As shown in FIG. 4A, each of the fixing seats 23 has a different structure.

As shown in FIG. 5, the headrail 1 has two guide tracks 11.

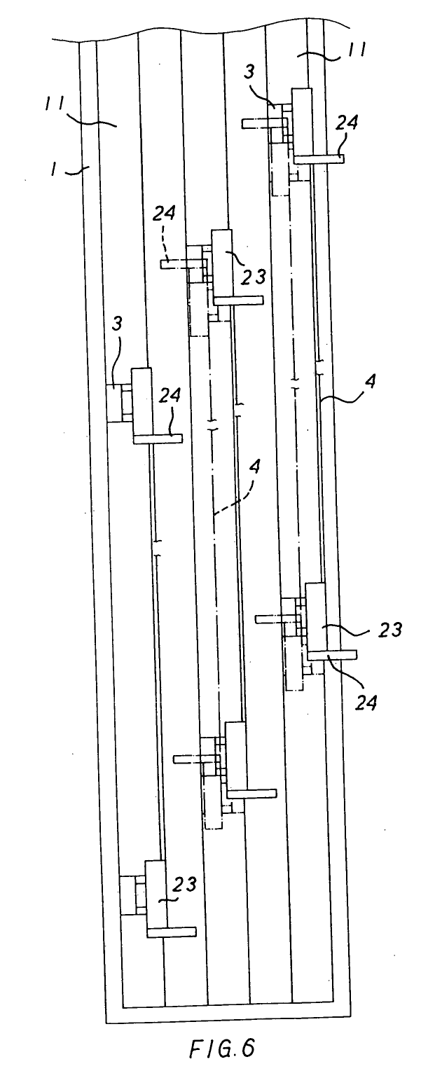

As shown in FIG. 6, the headrail 1 has three guide tracks 11.

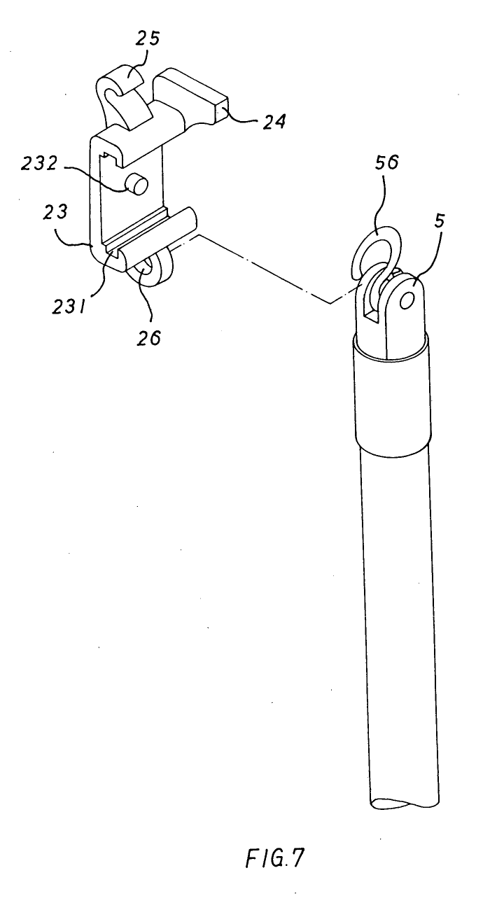

As shown in FIG. 7, each of the fixing seats 23 has a different structure and has a lower portion formed with a hook hole 26. Thus, a drive rod 5 has a hook 56 hooked on the hook hole 26 of one of the fixing seats 23 to drive and move the carriers 2 so as to expand and fold the covering members 4.

Accordingly, the snapping recess 231 of each of the fixing seats 23 is snapped onto the support plate 21 to secure the fixing seats 23 to the support plate 21, and the bonding layer 22 is clamped by the support plate 21 and the fixing seats 23 so as to assemble each of the carriers 2, so that the carriers 2 are assembled easily and rapidly, thereby facilitating a user assembling the carriers 2. In addition, each of the carriers 2 consists of the support plate 21, the bonding layer 22 and the fixing seats 23, so that each of the carriers 2 has a simplified construction, thereby decreasing costs of fabrication. Further, the snapping recess 231 of each of the fixing seats 23 is snapped onto the support plate 21 to reduce the volume of each of the carriers 2 largely, so that the carriers 2 are closer to the headrail 1 to reduce the distance between the covering members 4 and the headrail 1, thereby enhancing the aesthetic quality of the vertical blind. Further, the snapping recess 231 of each of the fixing seats 23 is directly snapped onto the support plate 21, so that the support plate 21 needs to prepare an area to combine each of the fixing seats 23, thereby decreasing the costs of material.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A vertical blind, comprising a headrail having a plurality of guide tracks, a carrier mechanism mounted on the headrail and including a plurality of carriers slidably mounted on the guide tracks of the headrail, and a plurality of covering members attached to the carriers of the carrier mechanism to move therewith, wherein each of the carriers includes:
an elongated support plate;
two fixing seats secured on a first side of the support plate respectively and each provided with a transversely extending push arm and an upwardly extending hook portion;
a bonding layer secured on a second side of the support plate and bonded to a respective one of the covering members to attach each of the covering members to the respective carrier.

2. The vertical blind in accordance with claim 1, wherein each of the carriers further includes two slides each hooked on the hook portion of a respective one of the fixing seats and each slidably mounted on a respective one of the guide tracks of the headrail.

3. The vertical blind in accordance with claim 1, wherein each of the fixing seats of each of the carriers has an inside formed with a snapping recess snapped onto the support plate to secure each of the fixing seats to the support plate.

4. The vertical blind in accordance with claim 3, wherein the snapping recess of each of the fixing seats has a cross-sectional profile corresponding to that of the support plate to secure each of the fixing seats to the support plate closely.

5. The vertical blind in accordance with claim 1, wherein the support plate of each of the carriers has two distal ends each formed with a fixing hole, and each of the fixing seats of each of the carriers has a side formed with a fixing post inserted into the respective fixing hole of the support plate to secure each of the fixing seats to the support plate to prevent each of the fixing seats from deflecting from the support plate.

6. The vertical blind in accordance with claim 1, wherein each of the fixing seats has a lower portion formed with a hook hole, and the vertical blind further comprises a drive rod having a hook hooked on the hook hole of one of the fixing seats to drive and move the carriers so as to expand and fold the covering members.

7. The vertical blind in accordance with claim 1, wherein the push arm is located at and extended outward from a side of an upper portion of each of the fixing seats of each of the carriers.

8. The vertical blind in accordance with claim 1, wherein the hook portion is located at and extended outward from the upper portion of each of the fixing seats of each of the carriers in an oblique manner.

9. The vertical blind in accordance with claim 1, wherein the bonding layer of each of the carriers has two distal ends each formed with a bent portion inserted between the first side of the support plate and a respective one of the fixing seats, so that the bonding layer is clamped by the support plate and the fixing seats.

10. The vertical blind in accordance with claim 1, wherein each of the covering members has an upper end provided with a bonding member bonded onto the bonding layer of the respective carrier.

11. The vertical blind in accordance with claim 1, wherein the carriers on each of the guide tracks are arranged in a staggered manner.

12. The vertical blind in accordance with claim 1, wherein the slides of the carriers on each of the guide tracks are arranged in a staggered manner.

13. The vertical blind in accordance with claim 1, wherein the push arms of the fixing seats of the carriers on each of the guide tracks are directed toward two opposite directions.

14. The vertical blind in accordance with claim 1, wherein the push arms of the fixing seats of the carriers on any two adjacent guide tracks are directed toward two opposite directions.

15. The vertical blind in accordance with claim 1, wherein the carriers on each of the guide tracks are linked by the slides arranged in a staggered manner, so that the front and rear carriers on each of the guide tracks are moved simultaneously.

16. The vertical blind in accordance with claim 1, wherein the carriers on each of the guide tracks drives and moves the carriers on an adjacent guide track by the push arms, so that the carriers are movable on the guide tracks in a serial manner so as to expand and fold the covering members.

17. The vertical blind in accordance with claim 3, wherein the snapping recess of each of the fixing seats is snapped onto the support plate to reduce a volume of each of the carriers, so that the carriers are relatively closer to the headrail to relatively reduce a distance between the covering members and the headrail.
